(19) United States
(12) Patent Application Publication
(10) Pub. No.: US 2018/0221974 A1
(43) Pub. Date: Aug. 9, 2018

(54) Depth Restrained Cutting Device

(71) Applicants: Dale Shanks, Corona, CA (US); Michael Lopez, Corona, CA (US); Sal Guzman, Corona, CA (US); Rick Rabago, Corona, CA (US)

(72) Inventors: Dale Shanks, Corona, CA (US); Michael Lopez, Corona, CA (US); Sal Guzman, Corona, CA (US); Rick Rabago, Corona, CA (US)

(21) Appl. No.: 15/426,732

(22) Filed: Feb. 7, 2017

(51) Int. Cl. B23D 61/00

(52) U.S. Cl. CPC B23D 61/006

(57) ABSTRACT

A depth restrained cutting device for preventing unintended contact with live wires includes a plate that is rigid. The plate is configured to couple to a cutting tool. A cutting edge is coupled to and extends radially from a circumference of the plate. A stop is coupled to a first face of the plate. The stop is dimensionally smaller than the plate. The stop is configured to contact a surface of a substrate that is to be cut, such as a polyvinyl chloride pipe, to prevent contact of the cutting edge with articles, such as wires, that are positioned in the substrate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed under 37 CFR 1.97 and 1.98

The disclosure and prior art relates to cutting devices and more particularly pertains to a new cutting device for preventing unintended contact with live wires.

### BRIEF SUMMARY OF THE INVENTION

An embodiment of the disclosure meets the needs presented above by generally comprising a plate that is rigid. The plate is configured to couple to a cutting tool. A cutting edge is coupled to and extends radially from a circumference of the plate. A stop is coupled to a first face of the plate. The stop is dimensionally smaller than the plate. The stop is configured to contact a surface of a substrate that is to be cut, such as a polyvinyl chloride pipe, to prevent contact of the cutting edge with articles, such as wires, that are positioned in the substrate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a depth restrained cutting device according to an embodiment of the disclosure.

FIG. 2 is a bottom view of an embodiment of the disclosure.

FIG. 3 is a side view of an embodiment of the disclosure.

FIG. 4 is a side view of an embodiment of the disclosure.

FIG. 5 is an in-use view of an embodiment of the disclosure.

### DETAILED DESCRIPTION OF THE INVENTION

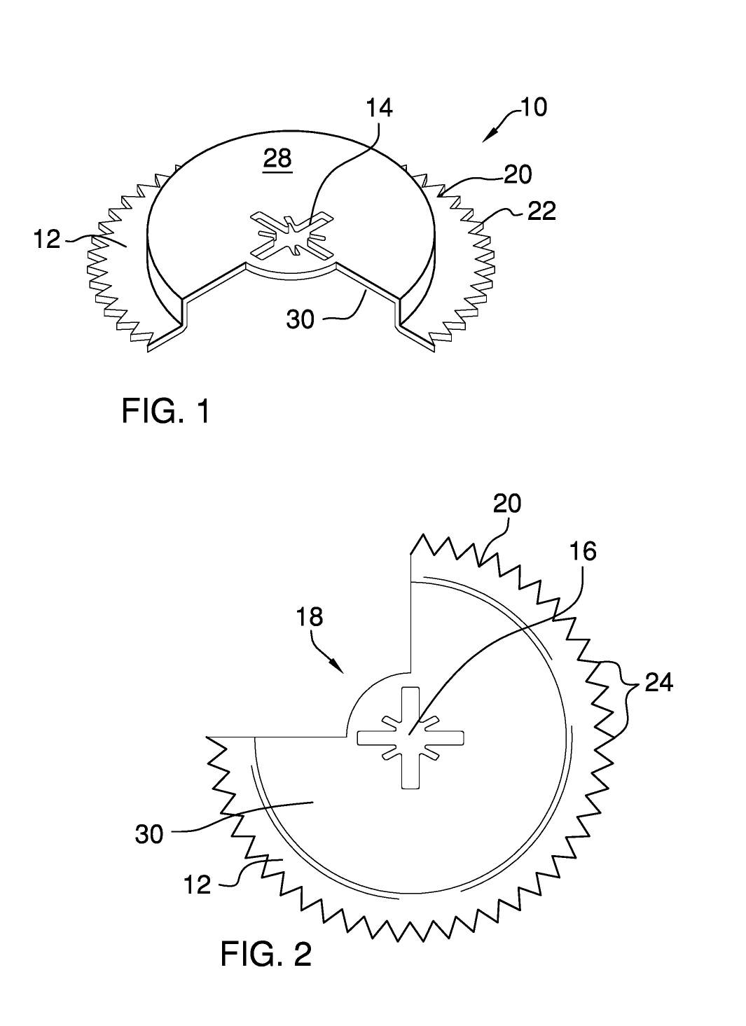

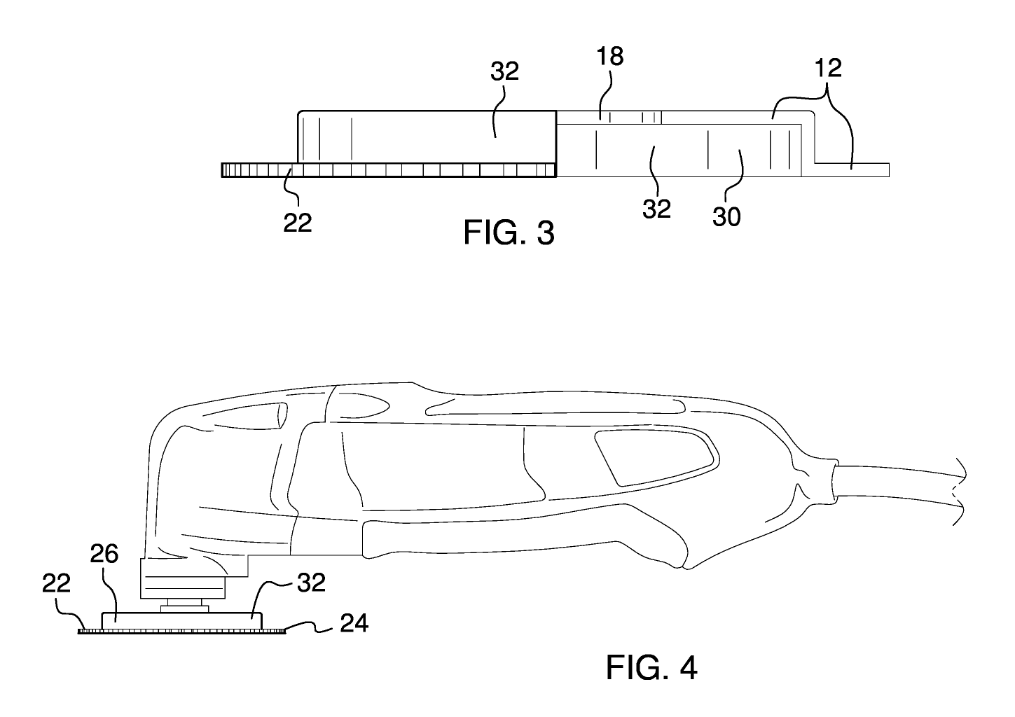

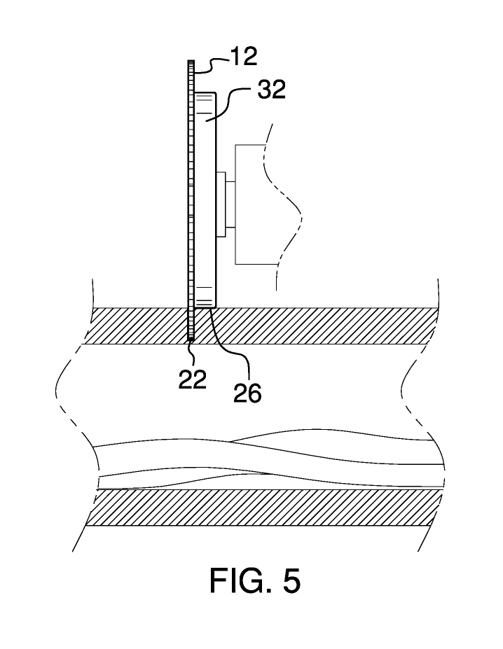

With reference now to the drawings, and in particular to FIGS. 1 through 5 thereof, a new cutting device embodying the principles and concepts of an embodiment of the disclosure and generally designated by the reference numeral 10 will be described.

As best illustrated in FIGS. 1 through 5, the depth restrained cutting device 10 generally comprises a plate 12 that is rigid. The plate 12 is configured to couple to a cutting tool. A coupler 14 is coupled to the plate 12. The coupler 14 is centrally positioned on the plate 12. The coupler 14 is configured to couple the plate 12 to the cutting tool. In one embodiment, the coupler 14 comprises a penetration 16 that is positioned through the plate 12. In another embodiment, the penetration 16 is substantially cross-shaped.

A cutout 18 is positioned in the plate 12. The cutout 18 extends from a circumference 20 of the plate 12 to proximate to the coupler 14. The cutout 18 is positioned in the plate 12 so that the plate 12 is configured to position the coupler 14 to couple to an oscillating multi-tool to couple the plate 12 to the oscillating multi-tool.

A cutting edge 22 is coupled to and extends radially from the circumference 20 of the plate 12. In one embodiment, the cutting edge 22 comprises a plurality of teeth 24. In another embodiment, each tooth 24 is V-shaped.

A stop 26 is coupled to a first face 28 of the plate 12. The stop 26 is dimensionally smaller than the plate 12. The stop 26 is configured to contact a surface of a substrate that is to be cut, such as a polyvinyl chloride pipe, to prevent contact of the cutting edge 22 with articles, such as wires, that are positioned in the substrate. In one embodiment, the stop 26 comprises a recess 30 that is positioned in the plate 12. The recess 30 defines a rim 32 that extends substantially perpendicularly from the plate 12. The rim 32 is configured to contact the surface of the substrate that is to be cut, such as the polyvinylchloride pipe, to prevent contact of the cutting edge 22 with the articles, such as the wires, that are positioned in the substrate. In another embodiment, the rim 32 and the cutting edge 22 are separated by a distance substantially equivalent to a wall thickness of the substrate to be cut, such as the polyvinylchloride pipe.

In use, the cutout 18 is positioned in the plate 12 so that the plate 12 is configured to position the coupler 14 to couple to an oscillating multi-tool to couple the plate 12 to the oscillating multi-tool. The rim 32 is configured to contact the surface of the substrate to be cut, such as the polyvinylchloride pipe, to prevent contact of the cutting edge 22 with the articles, such as the wires, that are positioned in the substrate.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A depth restrained cutting device comprising:
a plate, said plate being rigid, said plate being configured for coupling to a cutting tool;
a cutting edge coupled to and extending radially from a circumference of said plate;
a stop coupled to a first face of said plate, said stop being dimensionally smaller that said plate; and
wherein said stop is positioned on said plate such that said stop is configured for contacting a surface of a substrate being cut, such as a polyvinyl chloride pipe, for preventing contact of said cutting edge with articles, such as wires, positioned in the substrate being cut.

2. The device of claim 1, further including a coupler coupled to said plate, said coupler being centrally positioned on said plate, wherein said coupler is positioned on said plate such that said coupler is configured for coupling said plate to the cutting tool.

3. The device of claim 2, further including said coupler comprising a penetration positioned through said plate.

4. The device of claim 3, further including said penetration being substantially cross-shaped.

5. The device of claim 2, further including a cutout positioned in said plate, said cutout extending from said circumference of said plate to proximate to said coupler, wherein said cutout is positioned in said plate such that said plate is configured for positioning said coupler for coupling to an oscillating multi-tool to couple said plate to the oscillating multi-tool.

6. The device of claim 1, further including said cutting edge comprising a plurality of teeth.

7. The device of claim 6, further including each said tooth being V-shaped.

8. The device of claim 1, further including said stop comprising a recess positioned in said plate, said recess defining a rim extending substantially perpendicularly from said plate, wherein said recess is positioned in said plate such that said rim is configured for contacting the surface of the substrate being cut, such as the polyvinylchloride pipe, for preventing contact of said cutting edge with the articles, such as the wires, positioned in the substrate being cut.

9. The device of claim 9, further including said rim and said cutting edge being separated by a distance substantially equivalent to a wall thickness of the substrate being cut, such as the polyvinylchloride pipe.

10. A depth restrained cutting device comprising:
a plate, said plate being rigid, said plate being configured for coupling to a cutting tool;
a coupler coupled to said plate, said coupler being centrally positioned on said plate, wherein said coupler is positioned on said plate such that said coupler is configured for coupling said plate to the cutting tool, said coupler comprising a penetration positioned through said plate, said penetration being substantially cross-shaped;
a cutout positioned in said plate, said cutout extending from a circumference of said plate to proximate to said coupler, wherein said cutout is positioned in said plate such that said plate is configured for positioning said coupler for coupling to an oscillating multi-tool to couple said plate to the oscillating multi-tool;
a cutting edge coupled to and extending radially from said circumference of said plate, said cutting edge comprising a plurality of teeth, each said tooth being V-shaped;
a stop coupled to a first face of said plate, said stop being dimensionally smaller that said plate, wherein said stop is positioned on said plate such that said stop is configured for contacting a surface of a substrate being cut, such as a polyvinyl chloride pipe, for preventing contact of said cutting edge with articles, such as wires, positioned in the substrate being cut, said stop comprising a recess positioned in said plate, said recess defining an rim extending substantially perpendicularly from said plate, wherein said recess is positioned in said plate such that said rim is configured for contacting the surface of the substrate being cut, such as the polyvinylchloride pipe, for preventing contact of said cutting edge with the articles, such as the wires, positioned in the substrate being cut, said rim and said cutting edge being separated by a distance substantially equivalent to a wall thickness of the substrate being cut, such as the polyvinylchloride pipe; and
wherein said cutout is positioned in said plate such that said plate is configured for positioning said coupler for coupling to an oscillating multi-tool to couple said plate to the oscillating multi-tool, wherein said recess is positioned in said plate such that said rim is configured for contacting the surface of the substrate being cut, such as the polyvinylchloride pipe, for preventing contact of said cutting edge with the articles, such as the wires, positioned in the substrate being cut.
